(19) United States
(12) Patent Application Publication
(10) Pub. No.: US 2026/0103573 A1
(43) Pub. Date: Apr. 16, 2026

(54) PPTC MATERIAL WITH ONE-STEP HOT APPLICATION PROCESS

(71) Applicant: Littelfuse, Inc., Rosemont, IL (US)

(72) Inventors: Jianhua Chen, Sunnyvale, CA (US); Flory Zhou, Shanghai (CN); Jim Gong, Suzhou (CN); Bing Wang, Shanghai (CN); Marco Doms, Berlin (DE)

(73) Assignee: Littelfuse, Inc., Rosemont, IL (US)

(21) Appl. No.: 19/353,083

(22) Filed: Oct. 8, 2025

(30) Foreign Application Priority Data
Oct. 16, 2024 (CN) 202411443589.2

(51) Int. Cl. C08J 3/28; B29C 65/00; B29C 65/02; B29L 31/34; C08J 3/20; H01C 7/02

(52) U.S. Cl. CPC C08J 3/28; B29C 65/02; B29C 66/02241; B29C 66/028; B29C 66/71; C08J 3/203; H01C 7/028; B29L 2031/3406

(57) ABSTRACT

A method for preparing a preparing a polymeric positive temperature coefficient (PPTC) compound and conformally applying such compound to a substrate in accordance with an embodiment of the present disclosure may include preparing and mixing raw materials to form a PPTC mixture, processing the PPTC mixture through polymer compounding equipment, wherein the PPTC mixture is heated and is extruded as a PPTC compound, performing a beaming process on the polymer compound to establish crosslinking between polymer chains in the PPTC compound, and applying the PPTC compound to a substrate using a hot application process wherein the PPTC compound is heated and is conformally applied to a surface of the substrate.

### FIELD OF THE DISCLOSURE

This application claims the benefit of priority to, Chinese Patent Application No. 202411443589.2, filed Oct. 16, 2024, entitled “PPTC MATERIAL WITH ONE-STEP HOT APPLICATION PROCESS,” which application is incorporated herein by reference in its entirety.

### FIELD OF THE DISCLOSURE

Embodiments relate to the field of circuit protection devices, including fuse devices.

### BACKGROUND OF THE DISCLOSURE

Polymer positive temperature coefficient (PPTC) devices may be used as overcurrent or over-temperature protection devices, as well as current or temperature sensors, among various applications. In overcurrent or over-temperature protection applications, a PPTC device may be considered a resettable fuse, designed to exhibit low resistance when operating under predetermined conditions, such as low current. The resistance of the PPTC device may be altered by direct heating due to temperature increases in the environment of the PPTC device, or via resistive heating generated by electrical current passing through the PPTC device. For example, a PPTC device may include a composite PPTC material formed of a polymer material and a conductive filler, wherein the PPTC material transitions from a low resistance state to a high resistance state due to thermally-induced changes in the polymer material, such as a melting transition or a glass transition. At a transition temperature, sometimes called a “trip temperature,” where the trip temperature may range from room temperature to well above room temperature, the polymer material may expand and disrupt the electrically conductive network of conductive filler particles in the PPTC material, rendering the PPTC material much less electrically conductive. This change in resistance imparts a fuse-like character to PPTC materials, which resistance may be reversible when the PPTC material cools back to room temperature.

PPTC materials are typically formed by compounding a polymer material and a conductive filler and then extruding or molding the compounded mixture into chips or sheets of desired shapes. This type of process yields PPTC materials that are generally rigid and that are not amendable to being conformally applied to a flexible substrate as may be desirable for some applications (e.g., a flexible heater or temperature sensor). PPTC materials appropriate for flexible applications can be produced by a process that involves dissolving a polymer material in a solvent and mixing the resulting solution with a conductive filler to form a “PPTC ink.” The PPTC ink can then be printed or otherwise conformally applied to a desired surface, after which the ink is dried (i.e., the solvent is evaporated). This type of process is associated with various drawbacks. For example, the steps of dissolving the polymer material during preparation of the PPTC ink and removing the solvent after the ink is applied can be time-consuming. Additionally, the solvent necessary for dissolving the polymer material is environmentally unfriendly.

It is with respect to these and other considerations that the present disclosure is provided.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

A method for preparing a preparing a polymeric positive temperature coefficient (PPTC) compound and conformally applying such compound to a substrate in accordance with an embodiment of the present disclosure may include preparing and mixing raw materials to form a PPTC mixture, processing the PPTC mixture through polymer compounding equipment, wherein the PPTC mixture is heated and is extruded as a PPTC compound, performing a beaming process on the polymer compound to establish crosslinking between polymer chains in the PPTC compound, and applying the PPTC compound to a substrate using a hot application process wherein the PPTC compound is heated and is conformally applied to a surface of the substrate.

### BRIEF DESCRIPTION OF THE DRAWINGS

By way of example, various embodiments of the disclosed techniques will now be described with reference to the accompanying drawings, wherein:

FIG. 1 is a flow diagram illustrating a method of a preparing a polymeric positive temperature coefficient compound and conformally applying such compound to a substrate according to embodiments of the present disclosure.

### DESCRIPTION OF EMBODIMENTS

The present embodiments will now be described more fully hereinafter with reference to the accompanying drawings, wherein some exemplary embodiments are shown. The subject matter of the present disclosure may be embodied in many different forms and are not to be construed as limited to the embodiments set forth herein. These embodiments are provided so this disclosure will be thorough and complete, and will fully convey the scope of the subject matter to those skilled in the art. In the drawings, like numbers refer to like elements throughout.

As used herein, an element or operation recited in the singular and proceeded with the word “a” or “an” are understood as possibly including plural elements or operations, except as otherwise indicated. Furthermore, various embodiments herein have been described in the context of one or more elements or components. An element or component may comprise any structure arranged to perform certain operations. Although an embodiment may be described with a limited number of elements in a certain topology by way of example, the embodiment may include more or less elements in alternate topologies as desired for a given implementation. Note any reference to “one embodiment” or “an embodiment” means a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

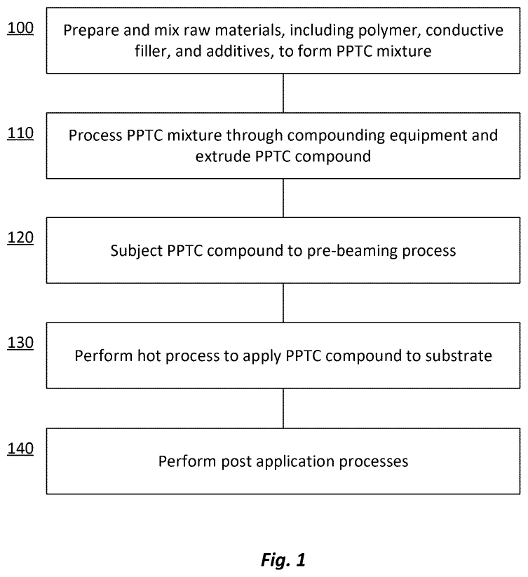

In accordance with the present disclosure, improved methods for preparing a polymeric positive temperature coefficient (PPTC) compound and conformally applying such compound to a substrate (e.g., a substrate within a PPTC device) are presented herein. A flow diagram illustrating an example of such a method is shown in FIG. 1.

Referring to block 100 of the example method shown in FIG. 1, raw materials that will form the PPTC compound may be collected and prepared (e.g., measured or weighed). The raw materials may include a polymer, a conductive filler, and, optionally, one or more additives. The polymer to be included in the PPTC compound may be selected from semicrystalline polymers, e.g., polyethylene copolymers (ethylene-vinyl acetate, ethylene and acrylic acid copolymer, ethylene butyl acrylate copolymer, polyolefin elastomer, polyethylene oxide, etc.), fluororesins (polyvinyl fluoride, polyvinyl fluoride, polytetrafluoroethylene, ethylene-tetrafluoroethylene copolymer, etc.), polyesters (polycaprolactone, etc.), polyethers (polyethylene glycol, polytetrahydrofuran, etc.), polyurethane, polyamide or its copolymer, and diene elastomer or its copolymer, etc. The present disclosure is not limited in this regard. The amount of polymer in the PPTC compound may be in a range of 60-95% by volume.

The conductive filler to be included in the PPTC compound may be selected from carbon black, carbon fiber, carbon nanotube, graphite, graphene, metal or metal carbide particles such as copper, nickel, tungsten carbide, titanium carbide, etc. The present disclosure is not limited in this regard. The amount of conductive filler in the PPTC compound may be in a range of 1-40% by volume.

The optional additives to be included in the PPTC compound may include, but are not limited to, inorganic fillers, flame retardant agents, antioxidants, coupling agents, arc suppressants, cross-linkers, pigments (e.g., to provide a visual indication of PPTC characteristics, such as trip temperature), etc.

The above-described raw materials, including the polymer, the conductive filler, and the optional additives, may be weighed, and appropriate quantities of each of the raw materials may be mixed together to form a “PPTC mixture.”

Referring to block 110 of the example method shown in FIG. 1, the PPTC mixture may be processed through conventional polymer compounding equipment, wherein the PPTC mixture may be heated and extruded. During such process, the PPTC mixture may be heated to a temperature in a range of 100-350 degrees Celsius depending on the type of polymer used, and the heated PPTC mixture may be extruded in the form of a wire, a sheet, or as pellets depending on the type of polymer compounding equipment used. The present disclosure is not limited in this regard. The extruded product is hereinafter referred to as “the PPTC compound.”

Referring to block 120 of the example method shown in FIG. 1, the PPTC compound may be subjected to a beaming process to establish crosslinking between polymer chains in the PPTC compound. This process may create a polymer chain network within the PPTC compound, which significantly contributes to the “resettable” nature of the PPTC compound (i.e., the ability of the PPTC compound to decrease in electrical resistance when the PPTC compound cools to a temperature below its trip temperature). The beaming process may be referred to as a “pre-beaming” process in this context because the beaming is performed before the PPTC compound is implemented in a device. The pre-beaming process can be performed using any conventional beaming technique and associated equipment, including, but not limited to, electron beaming and gamma irradiation. If electron beaming is used, the beaming dosage may be in a range of 1-100 Mrad. If gamma irradiation is used, the beaming dosage may be in a range of 1-100 kGy. The present disclosure is not limited in this regard. In various embodiments, the pre-beaming process may be omitted, and a beaming process may instead be performed after the PPTC compound is implemented in a device.

Referring to block 130 of the example method shown in FIG. 1, the PPTC compound may be applied to a substrate using a heated application process (hereinafter referred to as “the hot process”), wherein the PPTC compound may be melted or softened and may be applied to the substrate in a manner that conforms and adheres to the surface of the substrate. The hot process may include hot pressing, hot jetting, molding, etc. In various embodiments, the substrate may be a flexible polymer insulation film, such as may be formed of polyimide, polyester, polyamide, fluoropolymer, polyolefin, silicone, epoxy etc. The present disclosure is not limited in this regard. The substrate may form the basis of a flexible PPTC device (i.e., a PPTC device that can be conformally applied to another structure/surface) and may include a pair of metallic electrodes adhered thereto for connecting the PPTC device within a circuit. When the PPTC compound is applied to the substrate via the hot process, it may bridge and connect the metallic electrodes, providing a conductive pathway therebetween.

In various embodiments, the hot process of block 130 of the example method may be a hot pressing process. This may include cutting the PPTC compound to a desired size and shape to form a “PPTC element” suitable for application to the substrate (e.g., suitable for bridging the metallic electrodes of the PPTC device). The PPTC element may then put placed on the substrate, and the substrate may be placed in a hot press machine. The hot press machine may laminate the PPTC element to the substrate under heat and pressure. In various examples, the hot pressing may be performed at a temperature in a range of 80-350 degrees Celsius (depending on the melting temperature of the polymer), at a pressure in a range of 20-10000 psi (depending on the type of polymer and the hot press temperature), and for a time in a range of 1-6000 seconds. The present disclosure is not limited in this regard.

Referring to block 140 of the example method shown in FIG. 1, the PPTC device may be subjected to various processes after the PPTC element has been applied to the substrate. Such processes may be referred to as “post-application” processes. Post application processes may include, but are not limited to, beaming (in addition to or in lieu of the pre-beaming process described above), insulation coating, heat treatment, packaging, etc. The present disclosure is not limited in this regard.

Those of ordinary skill in the art will appreciate the numerous benefits provided by the method of the present disclosure. For example, the method of the present disclosure facilitates the application of a PPTC element to a flexible substrate in a conformal manner that requires only a single hot process step. Moreover, the method of the present disclosure does not require the use of any environmentally harmful solvents of type used conventionally used when applying a PPTC compound to a flexible substrate.

While the present embodiments have been disclosed with reference to certain embodiments, numerous modifications, alterations and changes to the described embodiments are possible while not departing from the sphere and scope of the present disclosure, as defined in the appended claims. Accordingly, the present embodiments are not to be limited to the described embodiments, and may have the full scope defined by the language of the following claims, and equivalents thereof.

What is claimed is:

1. A method for preparing a preparing a polymeric positive temperature coefficient (PPTC) compound and conformally applying such compound to a substrate, the method comprising:
preparing and mixing raw materials to for a PPTC mixture;
processing the PPTC mixture through polymer compounding equipment, wherein the PPTC mixture is heated and is extruded as a PPTC compound;
performing a beaming process on the polymer compound to establish crosslinking between polymer chains in the PPTC compound; and
applying the PPTC compound to a substrate using a hot application process wherein the PPTC compound is heated and is conformally applied to a surface of the substrate.

2. The method of claim 1, wherein the PPTC mixture comprises a polymer and a conductive filler.

3. The method of claim 2, wherein the polymer includes at least one of ethylene-vinyl acetate, ethylene and acrylic acid copolymer, ethylene butyl acrylate copolymer, polyolefin elastomer, polyethylene oxide, polyvinyl fluoride, polyvinyl fluoride, polytetrafluoroethylene, ethylene-tetrafluoroethylene copolymer, polycaprolactone, polyethylene glycol, and polytetrahydrofuran.

4. The method of claim 2, wherein the conductive filler includes at least one of carbon black, carbon fiber, carbon nanotube, graphite, graphene, copper, nickel, tungsten carbide, and titanium carbide.

5. The method of claim 2, wherein the PPTC mixture further comprises an additive.

6. The method of claim 5, wherein the additive includes at least one of an inorganic filler, a flame retardant agent, an antioxidant, a coupling agent, an arc suppressant, a cross-linker, and a pigment.

7. The method of claim 1, wherein the PPTC mixture is heated to a temperature in a range of 100-350 degrees Celsius prior to extrusion.

8. The method of claim 1, wherein beaming process is an electron beaming process.

9. The method of claim 1, wherein beaming process is a gamma irradiation process.

10. The method of claim 1, wherein the beaming process is a pre-beaming process performed prior to application of the PPTC compound to the substrate.

11. The method of claim 1, wherein the beaming process is a first beaming process performed prior to application of the PPTC compound to the substrate, the method further comprising a second beaming process performed after application of the PPTC compound to the substrate.

12. The method of claim 1, wherein the hot application process comprises one of hot pressing, hot jetting, and molding.

13. The method of claim 1, wherein the hot application is a hot pressing process wherein the PPTC compound is cut to a desired size and shape to form a PPTC element, and the PPTC element is laminated to the substrate in a hot press machine.

14. The method of claim 13, wherein the hot pressing process is performed at a temperature in a range of 80-350 degrees Celsius and at a pressure in a range of 20-10000 PSI.
